(19) United States
(12) Patent Application Publication
(10) Pub. No.: US 2015/0378649 A1
(43) Pub. Date: Dec. 31, 2015

(54) DEVICE INSTALLATION INFORMATION DISTRIBUTING APPARATUS AND DEVICE INSTALLATION INFORMATION DISTRIBUTING METHOD

(71) Applicant: Toshio AKIYAMA, Tokyo (JP)

(72) Inventor: Toshio AKIYAMA, Tokyo (JP)

(21) Appl. No.: 14/736,749

(22) Filed: Jun. 11, 2015

(30) Foreign Application Priority Data
Jun. 26, 2014 (JP) 2014-131823

(51) Int. Cl. G06F 3/12

(52) U.S. Cl. CPC G06F 3/1229; G06F 3/1285

(57) ABSTRACT

A device installation information distributing apparatus includes a distribution request acquirer configured to acquire a request to distribute device installation information, the device installation information including a function of installing a program to be installed in an information processing device to use a device connected to the information processing device via a network and a function of setting a communication with the device in accordance with the program; a device installation information updater configured to acquire an identifier of a target device to be used on the network and the device installation information for the target device, and update the device installation information by using the acquired identifier; and a device installation information distributor configured to transmit the updated device installation information to the information processing device that transmits the request.

### CROSS-REFERENCE TO RELATED APPLICATION

The present application claims priority to and incorporates by reference the entire contents of Japanese Patent Application No. 2014-131823 filed in Japan on Jun. 26, 2014.

### BACKGROUND OF THE INVENTION

1. Field of the Invention

The present invention relaters to a device installation information distributing apparatus and a device installation information distributing method.

2. Description of the Related Art

In recent years, a computerization of information tends to be promoted, which makes an image processing device such as a printer and a facsimile device used for outputting computerized information and a scanner used for computerizing a document indispensable. Such an image processing device is often configured as a multifunction peripheral capable of being used as a printer, a facsimile device, a scanner, and a copying machine by being provided with an imaging function, an image forming function, a communicating function, and the like.

Through an installation of driver software in an information processing device such as a PC (Personal Computer), a usage of such an image processing device via the PC, for example, an execution of formation and output of an image in response to a print job transmitted from the information processing device, becomes available. It is common in most combinations of an information processing device and an image processing device to make a usage of the image processing device available via the information processing device by installing a printer driver in the PC.

In such a usage of an image processing device via an information processing device, there are some cases where an authority of a user who uses an information processing device is limited in management. For example, there is a mode, for cost saving, of permitting only a monochrome printing and a double-side printing and locking an operational setting of driver software to disable a free change of the setting by a user. An arbitrary configuration of a system by a user is limited by controlling a login state to an information processing device to be a login state with an authority of a general user who is not authorized to change the system configuration.

However, an installation of new software is limited in the login state with the authority of a general user not authorized to change the system configuration. Therefore, even a necessary installation of driver software is limited in using a new device such as an image processing device. To avoid such a negative effect, proposed in Japanese Laid-open Patent Publication No. 2005-025477 has been a technique of embedding authentication information such as an ID and a password which enable authenticating a login to the information processing device as an administrator in a program for installing driver software, for example.

Besides, it is necessary for using a device from an information processing device via a network to set an address of the device on the network in the driver software in addition to the installation of the driver software. As a method to simplify this processing, proposed in Japanese Laid-open Patent Publication No. 2004-240490 has been a method of executing an environment setting processing with reference to device information after the driver software is installed, for example.

### SUMMARY OF THE INVENTION

It is an object of the present invention to at least partially solve the problems in the conventional technology.

According to an embodiment, there is provided a device installation information distributing apparatus that includes: a distribution request acquirer configured to acquire a request to distribute device installation information, the device installation information including a function of installing a program to be installed in an information processing device to use a device connected to the information processing device via a network and a function of setting a communication with the device in accordance with the program; a device installation information updater configured to acquire an identifier of a target device to be used on the network and the device installation information for the target device, and update the device installation information by using the acquired identifier; and a device installation information distributor configured to transmit the updated device installation information to the information processing device that transmits the request.

According to another embodiment, there is provided a device installation information distributing method that includes: acquiring a request to distribute device installation information, the device installation information including a function of installing a program to be installed in an information processing device to use a device connected to the information processing device via a network and a function of setting a communication with the device in accordance with the program; acquiring an identifier of a target device to be used on the network; acquiring the device installation information for the target device; updating the device installation information by using the acquired identifier; and transmitting the updated device installation information to the information processing device that transmits the request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an operation form of a system according to an embodiment of the present invention;

FIG. 2 is a block diagram of a hardware configuration of an information processing device according to the embodiment of the present invention;

FIG. 3 is a block diagram of a functional configuration of a driver server according to the embodiment of the present invention;

FIG. 4 illustrates an example of device management information according to the embodiment of the present invention;

FIG. 5 illustrates an example of package management information according to the embodiment of the present invention;

FIG. 6 illustrates an example of account management information according to the embodiment of the present invention;

FIG. 7 illustrates data configuration of a driver package according to the embodiment of the present invention;

FIG. 8 illustrates a setting content of a driver according to the embodiment of the present invention;

FIG. 9 is a sequence diagram of an operation of the system according to the embodiment of the present invention;

FIG. 10 is a sequence diagram of an operation of the system according to the embodiment of the present invention;

FIG. 11 illustrates an example of installation confirming information according to the embodiment of the present invention;

FIG. 12 illustrates an example of change notifying information according to the embodiment of the present invention; and

FIG. 13 is a flowchart of an operation of a PC having received the change notifying information according to the embodiment of the present invention.

### DETAILED DESCRIPTION OF THE PREFERRED EMBODIMENTS

An embodiment of the present invention will be explained below with reference to the accompanying drawings. The embodiment will be explained by taking a system in which an image processing device such as an MFP (Multifunction Peripheral) is connected to an information processing device such as a PC (Personal Computer) via a network as an example. An outline of the embodiment is an operation when driver software is installed so that the information processing device uses the MFP and information used in the installation in the system. Here, the driver software according to the embodiment, which is device utilization software to be installed in the information processing device so that the information processing device uses other devices, involves various kinds of operational settings for device utilization.

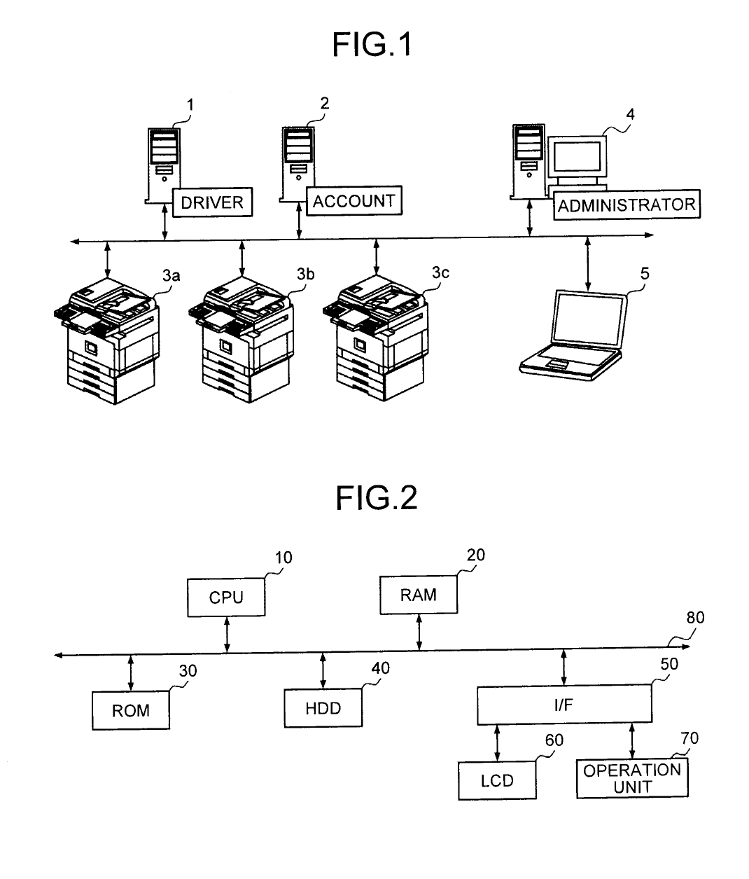

FIG. 1 illustrates an operation form of a system according to the embodiment. As illustrated in FIG. 1, the system according to the embodiment is provided with a driver server 1, an account server 2, a plurality of image processing devices 3a, 3b, and 3c (hereinafter referred to as “image processing device 3” as a whole), an administrator terminal 4, and a PC 5. The components illustrated in FIG. 1, which are connected to each other via a network such as an office LAN (Local Area Network), are capable of communicating with each other.

The driver server 1 according to the embodiment is a device installation information distributing apparatus that manages a driver package which is information used in installing driver software in the PC 5 so that the PC 5 uses the image processing device 3 via the network and distributes the package in response to a request by the PC 5. A program that causes the driver server 1 to operate is used as a device installation information distributing program. The account server 2 is a server that manages account information of a user who operates the PC 5 and account information of an administrator who manages the PC 5.

The image processing device 3 is a multifunction peripheral including image forming and outputting functions and image scanning function. The administrator terminal 4 registers, when a new image processing device is connected to the network, a driver package of the image processing device and updates information when a password for an administrator of the PC 5 is changed. The PC 5 is an information processing device that installs the driver software by downloading the driver package from the driver server 1 and uses the image processing device 3 via the network.

Here, the PC 5 according to the embodiment is used through a login with a general user authority with which changes in settings of various kinds are limited to prevent the settings from being arbitrarily changed and additional software from being installed and to encourage a usage of the PC 5 for an intended purpose in a manner intended by the administrator. However, since it is necessary to install driver software corresponding to each image processing device 3 so that the PC 5 uses the image processing device 3, a login with an administrator authority is required. The invention according to the embodiment is made on the assumption of such a condition.

Next, a hardware configuration of the image processing device as each of the devices constituting the system according to the embodiment will be explained with reference to FIG. 2. Here, the image processing device 3 is provided with an engine that realizes a scanner, a printer, and the like in addition to the hardware configuration illustrated in FIG. 2.

As illustrated in FIG. 2, the information processing device according to the embodiment has the same configuration as a common server, a PC, and the like. Specifically in the information processing device according to the embodiment, a CPU (Central Processing Unit) 10, a RAM (Random Access Memory) 20, a ROM (Read Only Memory) 30, an HDD (Hard Disk Drive) 40, and an I/F 50 are connected via a bus 80. Besides, an LCD (Liquid Crystal Display) 60 and an operation unit 70 are connected to the I/F 50.

The CPU 10, which is a computing unit, controls an entire operation of the information processing device. The RAM 20, which is a volatile storage medium capable of high-speed reading and writing of information, is used as a work area when the CPU 10 processes information. The ROM 30, which is a read-only non-volatile storage medium, stores programs including firmware. The HDD 40, which is a non-volatile storage medium capable of reading and writing of information, stores an OS (Operating System), various kinds of control programs, and application programs.

The I/F 50 connects the bus 80 with hardware of various kinds and a network to control them. The LCD 60 is a visual user interface that allows a user to check a state of the information processing device. The operation unit 70 is a user interface such as a keyset and a mouse which allow the user to input information to the information processing device. Since the driver server 1 and the account server 2 according to the embodiment are operated as servers that the user has no chance to operate directly, it is possible to eliminate the user interfaces such as the LCD 60 and the operation unit 70.

With this hardware configuration, the CPU 10 performs computing in accordance with the programs stored in the ROM 30 and programs loaded from the storage medium such as the HDD 40 or a not-shown optical disk to the RAM 20, so that a software controlling unit is configured. In combination with the software controlling unit configured in this manner and the hardware, a functional block like the driver server 1 according to the embodiment, realizing the function of the information processing device is configured.

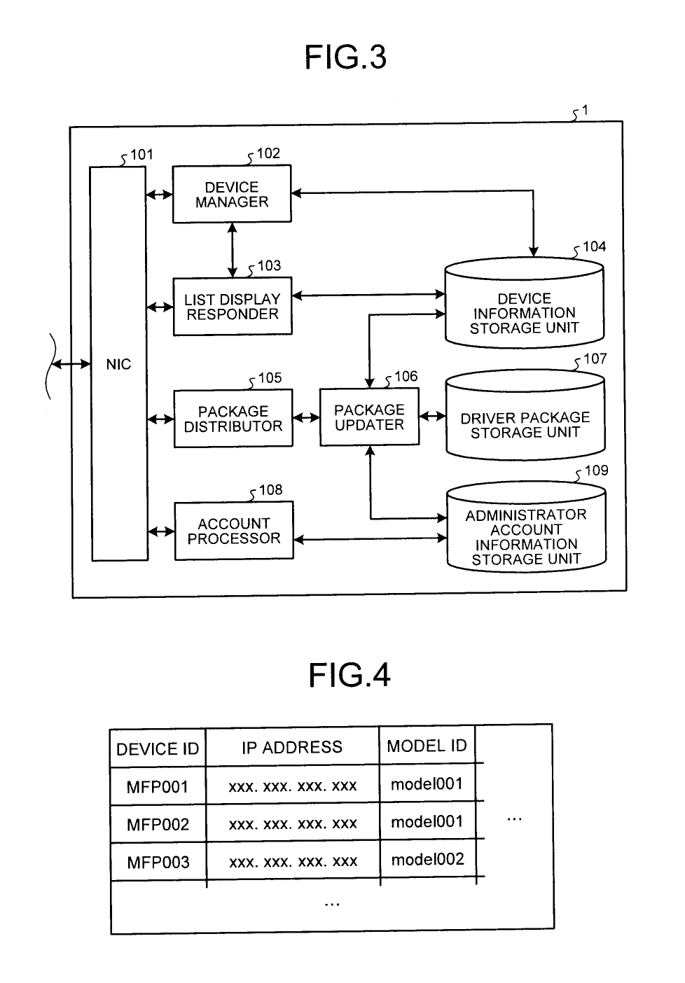

Next, a functional configuration of the driver server 1 according to the embodiment will be explained with reference to FIG. 3. FIG. 3 is a block diagram of a functional configuration of the driver server 1 according to the embodiment. As illustrated in FIG. 3, the driver server 1 according to the embodiment is provided with an NIC (Network Interface Card) 101, a device manager 102, a list display responder 103, a device information storage unit 104, a package distributor 105, a package updater 106, a driver package storage unit 107, an account processor 108, and an administrator account information storage unit 109.

The NIC 101 is a communication interface that allows the driver server 1 to transfer information with other devices via the network. The device manager 102 obtains communication-related information such as an IP address of each image processing device 3 via the network and stores the information in the device information storage unit 104. Communication information of each image processing device 3 is thus managed in the driver server 1.

The device manager 102 according to the embodiment transmits an information obtainment request to the image processing device 3 capable of communicating via the network by a broadcast, for example, and stores device management information in the device information storage unit 104 based on the information obtained from the response to the request. The device management information will be explained later.

The list display responder 103 refers to the information stored in the device information storage unit 104 in response to the request by the PC 5 for a list display and generates and transmits to the PC 5 a list of the image processing device 3 managed by a driver package in the driver server 1. The device information storage unit 104 stores and manages information of the image processing device 3 managed in the system according to the embodiment. Device management information stored in the device information storage unit 104 will be explained with reference to FIG. 4.

As illustrated in FIG. 4, the device management information according to the embodiment includes information of “device ID”, “IP address”, and “model ID”. The “device ID” is identification information that individually identifies the image processing device 3. The “IP address” is each address of the image processing device 3 on the network in the system according to the embodiment. The “model ID” is information indicating a model of each image processing device 3. The example in FIG. 4 shows that an image processing device “MFP001” and an image processing device “MFP002” are the same “model001”.

The package distributor 105 transmits the driver package via the network in response to the request by the PC 5. The package distributor 105 notifies the package updater 106 of a request for obtaining the driver package when receiving the request, by the PC 5, for distributing the driver package.

The package updater 106 obtains a target driver package from the driver package storage unit 107 in response to the request, by the package distributor 105, for obtaining a package, updates information included in the driver package by using the information obtained from the device information storage unit 104 and the administrator account information storage unit 109, and passes the updated information to the package distributor 105. A function of the package updater 106 will be explained later.

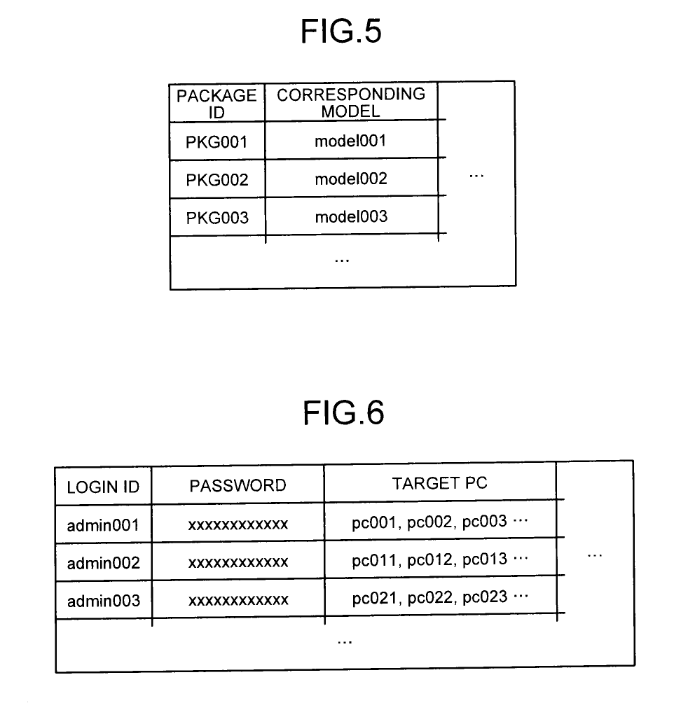

The driver package storage unit 107 is a storage unit that stores a driver package for using the image processing device 3 managed in the embodiment and package management information for managing the driver package. In other words, the driver package storage unit 107 functions as a device installation information manager. As illustrated in FIG. 5, the package management information according to the embodiment includes information of “package ID” and “corresponding model”.

The “package ID” is identification information that individually identifies a driver package. The “corresponding model”, which is information indicating a model of the image processing device 3 corresponding to a driver package identified by each package ID, corresponds to the “model ID” already explained with reference to FIG. 4.

Specifically, a driver package is managed not for each image processing device 3 but for each model of the image processing device 3 in the system according to the embodiment. Therefore, it is not necessary to redundantly manage the driver package of the same model, thereby realizing efficient information management. It is only necessary in the example according to the embodiment to manage one driver package for the image processing device “MFP001” and the image processing device “MFP002” illustrated in FIG. 4.

The account processor 108 updates the information stored in the administrator account information storage unit 109 in accordance with an order from the administrator terminal 4. The administrator account information storage unit 109 is a storage unit that stores a login ID and a password for using the PC 5 as an administrator. Account management information stored in the administrator account information storage unit 109 will be explained with reference to FIG. 6.

As illustrated in FIG. 6, the account management information according to the embodiment includes information of “login ID”, “password”, and “target PC”. The “login ID” is identification information of an administrator who is able to log on to the PC 5 according to the embodiment with an administrator authority. The “password” is a password for each “login ID”. The “target PC” is information indicating a PC to which a login as an administrator is available.

While only one PC 5 is illustrated as a minimum configuration example in FIG. 1, PCs corresponding to the number of users who use the system are connected in fact. Since all of the PCs are not managed by a single administrator but shared in the care and managed by a plurality of administrators, a plurality of PCs for each “login ID” are associated as the “target PC” as illustrated in FIG. 6.

The information in FIG. 6 is accumulated after authentication information of administrator authorities of information processing devices including the PC 5 connected to the system is selected from account information of users and administrators managed in the account server 2. In addition to the case where this processing is executed manually by the administrator who operates the administrator terminal 4 as explained above, the account processor 108 may work with the account server 2 and obtain automatically authentication information of the administrator authority managed in the account server 2 to update the information stored in the administrator account information storage unit 109.

The package updater 106 is notified of the “device ID” illustrated in FIG. 4 in receiving the request for obtaining a driver package from the package distributor 105. The package updater 106 first refers to the device management information in FIG. 4 in accordance with the notified “device ID” and obtains a “model ID” associated with the target “device ID”. The package updater 106 then refers to the package management information in FIG. 5 in accordance with the obtained “device ID”, identifies a corresponding driver package, and obtains the target driver package.

The package updater 106 further obtains an IP address of the target image processing device 3 from the device management information, obtains authentication information of the administrator of the PC 5 having requested for an installation of the driver package from the account management information, and updates the driver package by using the obtained information.

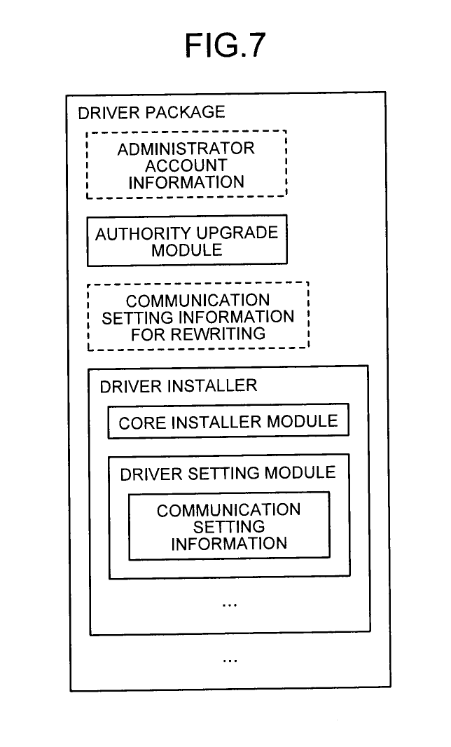

Here, a content of the driver package updated by the package updater 106 according to the embodiment will be explained with reference to FIG. 7. FIG. 7 illustrates information included in a driver package according to the embodiment. As illustrated in FIG. 7, the driver package according to the embodiment includes information of “administrator account information”, “authority upgrade module”, “communication setting information for rewriting”, and “driver installer”. In FIG. 7, information surrounded by a broken line is added by the package updater 106 on the occasion of the distribution of the driver package.

The “administrator account information”, which is authentication information of the administrator of the PC 5 to which the driver package is distributed, corresponds to the “login ID” and the “password” obtained from the account management information by the package updater 106. As the “administrator account information” is included in the driver package, it becomes possible to transit from a login state as a general user to a login state as an administrator when the installation of the driver by the driver package is executed in the PC 5. In other words, the “administrator account information” is used as login information.

In the embodiment, the “administrator account information” is not included in the driver package in advance but obtained and added by the package updater 106 on the occasion of the distribution of the driver package as explained above. The “administrator account information” may be included in the driver package in advance as long as the “login ID” and the “password” in FIG. 6 are fixed, however, such information is supposed to be changed regularly. It is therefore possible by obtaining and adding the “administrator account information” on the occasion of the distribution of the driver package like the manner according to the embodiment to include accurate “administrator account information” in the driver package even when the “login ID” and the “password” are regularly changed.

The significance of the “administrator account information” is to upgrade the login state in the PC 5 from the general user authority to the authority with which an installation of a program is allowed. Therefore, login information as an administrator is not necessarily required and login information of an authority with which an installation of a program in the PC 5 is allowed may do.

The “authority upgrade module” is information of a software program causing an execution of a processing for a transition from the login state as a general user to a login state as an administrator when the driver by the driver package is installed in the PC 5. In the PC 5, the CPU 10 performs computing in accordance with the program of the “authority upgrade module” and refers to the “administrator account information”, resulting in a process upgrade from the login state as a general user to the login state as an administrator. In other words, the “authority upgrade module” is used as login state changing information.

The “communication setting information for rewriting”, which is communication setting information including an IP address and the like of the image processing device 3 whose usage is enabled by the installation of the driver package, corresponds to the “IP address” obtained by the package updater 106 from the device management information. In other words, the “communication setting information for rewriting” is information including an identifier, on the network, of a device which is to be used newly in the PC 5.

While the case of using the IP address as the communication setting information for rewriting is taken as an example in the embodiment, the present invention is not limited thereto, any information indicating an address of the image processing device 3 on the network may be similarly used, and a host name, a URL (Uniform Resource Locator), and the like other than the IP address may be used.

The “driver installer” is information for installing driver software of the target image processing device 3 which is enabled to be used in the PC 5. As illustrated in FIG. 7, the “driver installer” includes a “core installer module” and a “driver setting module”.

The “core installer module” is a software program that realizes a function of installing a printer driver allowing the PC 5 to drive and control the image processing device 3 via the network. The “driver setting module” is a software program that realizes a function of setting an operation of the installed printer driver. Especially, the driver setting module according to the embodiment provides a communication setting function that enables the driver software to be installed by the driver package in the PC 5 to communicate with the image processing device 3.

As illustrated in FIG. 7, the “driver setting module” includes “communication setting information”. The communication setting information is referred to for performing a communication setting of the target image processing device 3 when the CPU 10 performs computing in accordance with the “driver setting module” to perform the operational setting in the PC 5.

In the system according to the embodiment, the package updater 106 obtains the IP address from the device management information and includes the IP address as the “communication setting information for rewriting” in the driver package on the occasion of distributing the driver package. Therefore, when the operational setting is executed due to the function of the “driver setting module” in the PC 5, the “communication setting information” is rewritten with the “communication setting information for rewriting” and the communication setting is then executed. This configuration is adopted due to the following reason.

The “driver installer” is an installer file whose extension is “msi” when Windows® is used as basic software of the PC 5, for example. If the installer file is configured to refer to information locating outside the file, the configuration becomes complicated. Therefore, it is preferable that the information to be referred to by the “core installer module” and the “driver setting module” is included in the “driver installer”.

Here, since it is necessary in the system according to the embodiment to execute the installation after the login state in the PC 5 is transited from the general user to the administrator as explained, it is necessary to perform the communication setting of the installed printer driver in the state where the login state is transited to the administrator authority. It is therefore necessary that information such as the “IP address” used for the communication setting is included in the driver package.

However, each driver installer corresponds not one on one to the image processing device 3 but one on one to the model of the image processing device 3 as explained with reference to FIG. 5. It is therefore impossible to set the “communication setting information” included in the “driver installer” for each image processing device 3 in storing the driver package in the driver package storage unit 107.

In response, the “communication setting information for rewriting” is included in the driver package in the distribution of the driver package and the internal “communication setting information” is overwritten with the “communication setting information for rewriting” on the occasion of the operation of the setting due to the function of the “driver setting module” as explained above, so that the problem described above can be resolved. In other words, the “communication setting information” is information corresponding to the identifier, on the network, of the target device to use and is a tentative identifier registered in advance.

The driver package according to the embodiment is configured as a compressed file which is provided with a self-decompression function and in which a scenario for an automatic module execution is set. In the PC 5 having obtained the driver package illustrated in FIG. 7, the installation of the driver software and the operational setting are automatically executed when the CPU 10 performs a processing in accordance with program information included in the driver package.

Here, though being dummy information which is to be rewritten in the distribution of the driver package, the “communication setting information” included in the driver installer is preferably configured not to be senseless data or void data but to be an address of the actual image processing device 3 corresponding to the driver installer. It thereby becomes possible to confirm the operation of the driver installer generated as an msi file.

As explained so far, the driver package according to the embodiment is information that provides the function of installing the driver software as a program to be installed in the PC 5 for the purpose of using the image processing device 3 via the network and the function of setting the operation of the program. In other words, the driver package is used as device installation information and a device installation program that enable installation of the device in the PC 5.

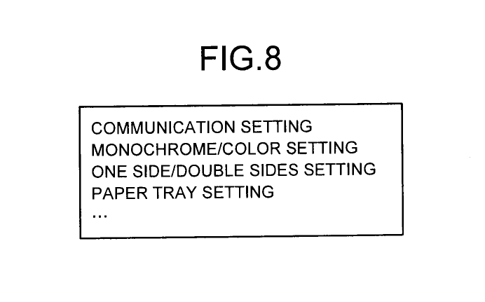

FIG. 8 illustrates a setting content when the CPU 10 performs computing in accordance with the “driver setting module” in the PC 5. As illustrated in FIG. 8, a “monochrome/color setting”, a “one side/double sides setting”, and a “paper tray setting”, other than the “communication setting” described above, for the occasion where the PC 5 uses the image processing device 3 to form and output am image are executed due to the function of the “driver setting module”.

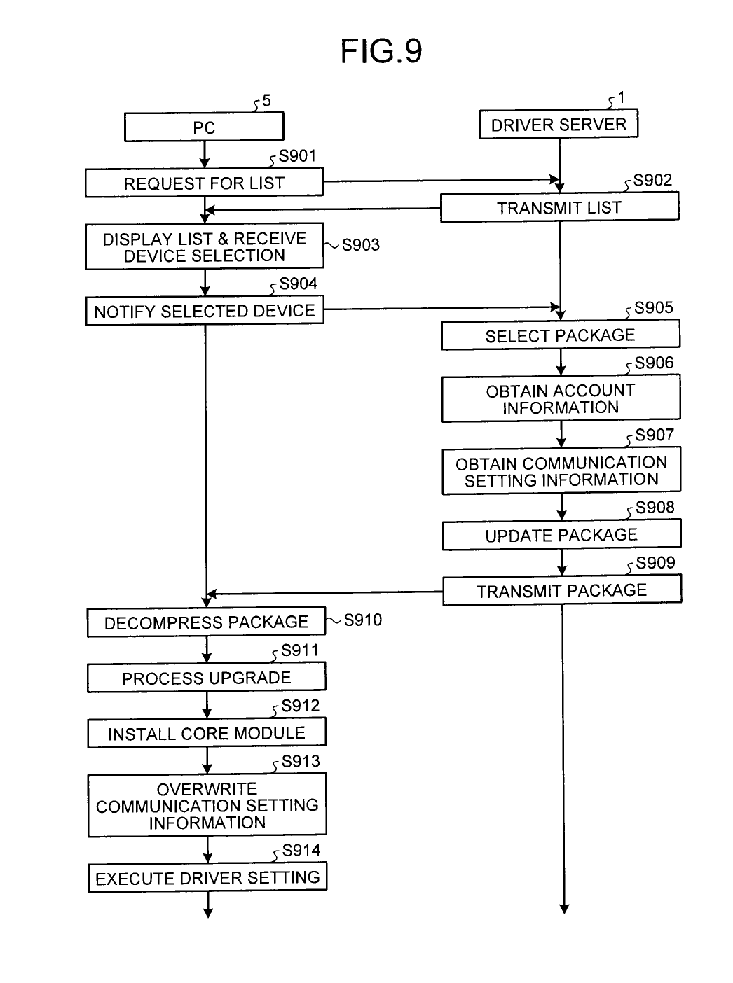

Next, a distribution and an operation of the installation of the driver package according to the embodiment will be explained. FIG. 8 is a sequence diagram of an operation of the system according to the embodiment. As illustrated in FIG. 9, a user who wants to use the image processing device 3 first operates the PC 5 to request for a list of available image processing device 3 to use from the driver server 1. The PC 5 thus requests for a list from the driver server 1 (S901).

In the driver server 1 having received the request for the list at step S901, the list display responder 103 obtains the request, obtains information of the device from the device information storage unit 104, and generates information of the list. On this occasion, it is possible to limit the image processing device 3 to be used depending on each PC and user by sorting out the image processing device 3 to be included in the list based on the identification information of the PC 5 as an origin of the request and information of the user who logs on to the PC 5.

When information of the list is generated, the list display responder 103 transmits the list information to the PC 5 as the origin of the request (S902). The PC 5 having received the list information makes the LCD 60 display the list of the available image processing device 3 to use based on the received list information to receive a selecting operation from the user with respect to the displayed list (S903). When a target image processing device 3 to use is selected by the user, the PC 5 notifies the driver server 1 of the selected device (S904).

In other words, the processing at step S904 is a processing of requesting for a distribution of a driver package corresponding to the selected device. In the driver server 1, the package distributor 105 obtains and notifies the package updater 106 of the notification of the selected device. In other words, the package distributor 105 functions as a distribution request obtaining unit at step S904.

In the driver server 1, the package distributor 105 obtains and notifies the package updater 106 of the notification of the selected device. As explained above, what is notified on this occasion is identification information of the image processing device 3 as the selected device and identification information of the PC 5 as the origin of the request. The package updater 106 first refers to the device information storage unit 104 based on the identification information of the image processing device 3, confirms the “model ID”, and obtains a target driver package from the driver package storage unit 107 in accordance with the confirmed result (S905).

The package updater 106 then obtains administrator account information from the administrator account information storage unit 109 based on the identification information of the PC 5 as the origin of the request (S906). The package updater 106 further obtains communication setting information from the device information storage unit 104 based on the identification information of the target image processing device 3 (S907).

On completion of the obtainment of the information, the package updater 106 includes the “administrator account information” and the “communication setting information for rewriting” in the driver package as explained in FIG. 7 to update the driver package (S908). In other words, the package updater 106 functions as a device installation information updater.

The driver package updated by the package updater 106 is transmitted to the PC 5 as the origin of the transmission of the request by the package distributor 105 (S909). In other words, the package distributor 105 functions as a device installation information distributor.

In the PC 5 having received the driver package, the CPU 10 performs computing in accordance with the information of the driver package, so that the driver package as a compressed file as explained above is decompressed (S910). When the decompression is performed, the CPU 10 then executes a processing based on the scenario information included in the driver package, and a process upgrade of the login state in the PC 5 is first performed from the general user authority to the administrator authority in accordance with the function of the “authority upgrade module” (S911).

The transition to the login state with the administrator authority via the processing at step S911 leads to a state in which a new software program is installable in the PC 5. When the CPU 10 then performs computing in accordance with the core installer module, the core module of the driver software is installed (S912).

While the setting is executed by the driver setting module on completion of the installation of the core module, the “communication setting information” included in the driver setting module is overwritten with the “communication setting information for rewriting” before the execution of the setting as explained in FIG. 7 (S913).

When the CPU 10 performs computing in accordance with the driver setting module, the operational setting of the driver is executed (S914). At step S914, the operational setting for the items explained in FIG. 8 is executed. Through this processing, the installation and the operational setting of the driver software by the driver package according to the embodiment are completed.

As explained, it becomes possible in the system according to the embodiment to install the driver software when the “administrator account information” is included in the driver package and the state is transited to the login state with the administrator authority in the installation of the driver due to the function of the “authority upgrade module” even in the case where the target PC 5 to which the driver software is to be installed is operated with a general user authority with which an installation of a new software is not authorized.

In the system according to the embodiment, the “administrator account information” is not included in each driver package in advance but obtained by the package updater 106 from the administrator account information storage unit 109 and included as information in the driver package when the driver package is distributed in response to the request by the PC 5. Even in the case where the administrator account information is regularly changed, it is therefore not necessary to update the content of the driver package stored in the driver package storage unit 107 each time of the changes. Besides, even the case where the administrator account information differs depending on the information processing device, having requested for the driver package, as the origin of the request can also be dealt with.

In the system according to the embodiment, the operation of the PC 5 by the user is limited and a change in the operational setting of the installed driver software is locked and disabled, so that the user is obligated to use the PC 5 in a usage manner intended by the administrator. Therefore, it is impossible to perform the communication setting of the image processing device 3 in the PC 5 after the installation of the driver software is completed and the usage authority of the PC 5 returns to the general user authority.

However, by including communication setting information in the driver package in the system according to the embodiment, the communication setting with the target image processing device 3 is performed during the transition to the login state with the administrator authority in the installation and the operation setting of the driver software using the driver package. It is therefore possible to perform the communication setting in installing the driver software irrespective of the operation environment of the system.

Besides, communication setting information is not included in the driver package in advance but embedded depending on the target image processing device 3 as the “communication setting information for rewriting” in the driver package when the driver package is distributed. Therefore, it is not necessary to store the driver package in advance for each image processing device 3 and it is only necessary to store the driver package for each model of the image processing devices 3 as explained in FIG. 5, so that information to be stored can be streamlined.

In the explanation in FIG. 9, the case of including the “administrator account information” in the driver package in the driver server 1 on the occasion of the distribution of the driver package and then distributing the administrator account information to the PC 5 is taken as an example. However, this is just an example and it is only necessary that the “administrator account information” can be referred to when the login state of the PC 5 is upgraded from the general user authority to the administrator authority in installing the driver software by using the driver package in the PC 5. Another mode will be explained below.

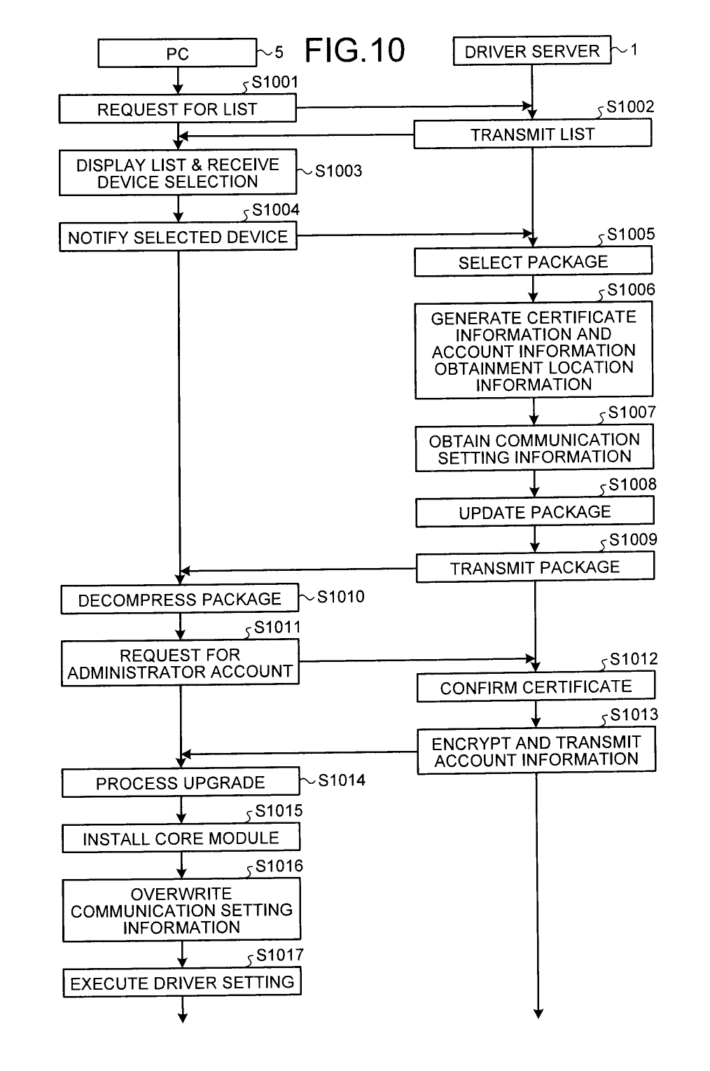

FIG. 10 is a sequence diagram of an example of a case of obtaining administrator account information in the process upgrade in the PC 5. As illustrated in FIG. 10, the processing is executed at steps S1001 to S1005 similarly to the steps S901 to S905 in FIG. 9. In the driver server 1, when obtaining a target driver package, the package updater 106 then generates certificate information that enables an authentication in having the PC 5 obtain the administrator account information and information of the obtainment location of the account information (S1006). These pieces of information are used as request information with which the PC 5 requests for the administrator account information from the driver server 1.

The information of the obtainment location of the account information includes, other than the network address of the driver server 1, an identifier for requesting for account information from the driver server 1 and the like. After that, the processing is executed at steps S1007 to S1010 similarly to the steps S907 to S910 in FIG. 9. It should be noted here that the package updater 106 includes, in place of the administrator account information illustrated in FIG. 7, the certificate information and the information of the obtainment location of the account information generated at step S1006 in the driver package at step S1008.

When the driver package is decompressed in PC 5, the CPU 10 that performs a processing in accordance with the authority upgrade module requests for an administrator account from the driver server 1 based on the information of the obtainment location of the account information included in the driver package (S1011). On this occasion, the information of the certificate included in the driver package is attached. In the driver server 1 having received from the PC 5 the request for the administrator account, the account processor 108 communicates with an authentication authority based on the information of the attached certificate to confirm the validity of the certificate (S1012).

When the validity of the certificate is confirmed, the account processor 108 encrypts and transmits to the PC 5 the requested administrator account information (S1013). In other words, the account processor 108 functions as a login information distributor at step S1013. In the PC 5 having received the encrypted administrator account information, the CPU 10 that performs a processing in accordance with the authority upgrade module decrypts the encrypted administrator account information and performs the process upgrade processing similarly to the step S911 in FIG. 9 based on the decrypted information (S1014).

At steps S1015 to S1017, the same processing as the steps S912 to S914 in FIG. 9 is executed thereafter. Through this processing, the operation of the system according to the example in FIG. 10 is completed. It is possible also in this mode to obtain the same advantageous effect as explained above.

When the driver server 1 distributes a driver package in response to the request by the PC 5, identification information of the PC 5 and identification information of a user who operates the PC 5 may be stored by being associated with the identification information of the image processing device 3 to which the driver package is distributed. When there arises a change in the state of the image processing device 3, it is possible for the device manager 102 to notify the PC 5 which downloads the driver package of the image processing device 3 having the change and encourage an update and a change in the setting of the driver. Such an example will be explained below.

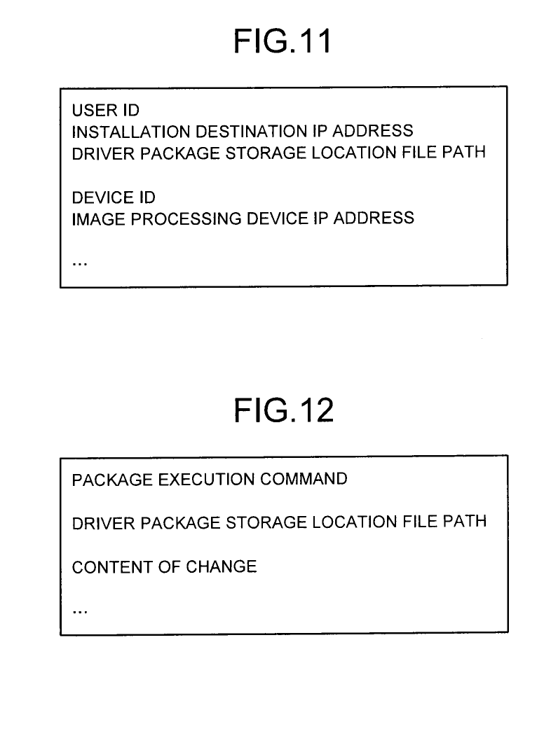

FIG. 11 illustrates an example of installation confirming information to be transmitted from the PC 5 to the driver server 1 after the installation and the operational setting of the driver software are completed in the PC 5. As illustrated in FIG. 11, the installation confirming information includes a “user ID”, an “installation destination IP address”, and a “driver package storage location file path” as information regarding the PC 5, and include a “device ID” and an “image processing device IP address” as information regarding the target image processing device 3 whose driver software is installed. The information illustrated in FIG. 11 is used as device installation confirming information.

The “user ID” is identification information of a user who logs on to the PC 5 to which the driver software is installed. The “installation destination IP address” is an IP address of the PC 5 to which the driver software is installed. The “driver package storage location file path”, which is information indicating a storage area in which the driver package which is downloaded to the PC 5 is stored, is a file path, for example.

The “device ID”, which is identification information of the target image processing device 3 whose driver software is installed, corresponds to the “device ID” in FIG. 4. The “image processing device IP address” is an IP Such installation confirming information are stored and managed in the driver server 1. The management of the installation confirming information can be performed by the device manager 102, for example. In other words, the device manager 102 functions as a device-installation-confirming-information manager.

When there arises a change in then IP address and the device configuration of the image processing device 3 included in the system, the device manager 102 obtains the “device ID” of the image processing device 3 having the change and narrows down installation confirming information based on the “device ID” illustrated in FIG. 11. It is possible to recognize the PC 5 and the user to be affected by the change arising in the image processing device 3 in the driver server 1, by referring to the “user ID” and the “installation destination IP address” of the installation confirming information narrowed down in this manner.

Detection of the occurrence of a change in the state of the image processing device 3 and the content of the change is realized by the device manager 102, for example. In other words, the device manager 102 functions as a device state change detector.

In the driver server 1 that recognizes the PC 5 to be affected by the change having arisen in the image processing device 3 in this manner, the device manager 102 transmits change notifying information as illustrated in FIG. 12 to the recognized PC 5. In other words, the device manager 102 functions as a state change notifying unit. For a mode of transmitting information, a mode of transmission based on the “installation destination IP address” and the “user ID” by using the interface of the system according to the embodiment or a mode of transmission to a mail address identified by the “user ID” can be considered.

The “package execution command” illustrated in FIG. 12 is an execution order to cause an execution of the driver package. The “driver package storage location file path” is the same information as that illustrated in FIG. 11. The “content of change”, which is information indicating a content of the change having arisen in the image processing device 3, indicates a changed IP address when there arises a change in IP address, for example.

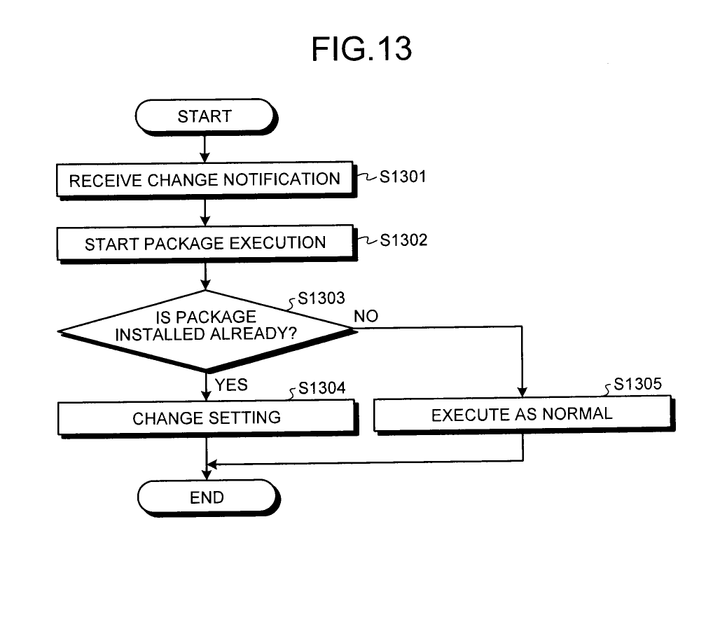

Next, an operation of the PC 5 having received the information illustrated in FIG. 12 will be explained with reference to FIG. 13. When receiving the information illustrated in FIG. 12 (S1301), the CPU 10 that performs a processing in accordance with the “package execution command” starts the execution of the driver package (S1302) as illustrated in FIG. 13. At step S1302, the “driver package storage location file path” illustrated in FIG. 12 is referred to and a target driver package is read out.

Here in the PC 5 to which the driver software is installed by the operations in FIGS. 9 and 10, an identifier indicating that the installation is performed (hereinafter referred to as “installation complete identifier”) is stored by being associated with the installed driver package. The storage of the installation complete identifier is realized as a file or by a registry recording.

When the execution of the package is started at step S1302 in FIG. 13, the CPU 10 that performs a processing in accordance with the information of the driver package checks the installation complete identifier (S1303) and changes the setting of the driver software based on the information of the “content of change” illustrated in FIG. 12 (S1304) when the completion of the installation is confirmed (“Yes” at step S1303). That is to say, the CPU 10 that performs a processing in accordance with the information of the driver package confirms the installation complete identifier and changes the setting of the driver software based on the “content of change” when the information illustrated in FIG. 12 is notified.

On the other hand, when the completion of the installation is not confirmed (“No” at step S1303), the CPU 10 that performs a processing in accordance with the information of the driver package executes the driver package similarly to the processing explained in FIGS. 9 and 10. In this manner, the processing from the step S1303 is realized by the function included in the driver package.

It is possible by automatically notifying, when there arises a change in the image processing device 3 included in the system, the user of the change and encouraging an update of the driver software with this system configuration to avoid a state where a usage of the image processing device 3 becomes unavailable and to improve a user friendliness.

In the example in FIG. 13, the case of automatically changing the setting in accordance with the information of the “content of change” is taken as an example in the explanation. However, this is just an example, and a GUI (Graphical User Interface) that enables the user to confirm whether or not to change the setting may be displayed and the necessity of changing the setting may be determined depending on the operation of the GUI by the user. It is thus possible to have the user recognize that there arises a change in the setting and to prevent unintended change in the setting.

In the example in FIG. 13, the case where the execution of the package is automatically started in the PC 5 having received the change notification is taken as an example and explained. However, this is just an example and the necessity of the execution of the package may also be confirmed by the user similarly.

In the embodiment, a printer driver for using the image processing device 3 is taken as an example of the driver software to be installed and explained. However, this is just an example, the invention is not limited to the printer driver, and any driver software, such as driver software for using a scanner, for using a device connected via a network is similarly applicable.

According to the embodiment, it is possible to enable a setting for a communication with a device in installing a program for using, via an information processing device, the device connected via a network, irrespective of operation environment of the device and the information processing device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device installation information distributing apparatus comprising:
a distribution request acquirer configured to acquire a request to distribute device installation information, the device installation information including a function of installing a program to be installed in an information processing device to use a device connected to the information processing device via a network and a function of setting a communication with the device in accordance with the program;
a device installation information updater configured to acquire an identifier of a target device to be used on the network and the device installation information for the target device, and update the device installation information by using the acquired identifier; and
a device installation information distributor configured to transmit the updated device installation information to the information processing device that transmits the request.

2. The device installation information distributing apparatus according to claim 1, wherein
the device installation information updater updates the device installation information to include the acquired identifier in the device installation information, and
the function of setting the communication includes a function of updating a tentative identifier registered in advance by using the identifier added by the device installation information updater.

3. The device installation information distributing apparatus according to claim 1, further comprising:
a device-installation-confirming-information manager configured to store, in a storage medium, device installation confirming information in which information identifying the information processing device to which the device installation information is transmitted is associated with information for identifying the device to be used through the device installation information;
a device state change detector configured to detect, when a state of the device connected via the network is changed, a content of the change; and
a state change notifying unit configured to notify the information processing device identified by the identifier associated with an identifier of the device whose state is changed in the device installation confirming information, of the content of the change.

4. The device installation information distributing apparatus according to claim 3, wherein
the device-installation-confirming-information manager stores the device installation confirming information so as to be further associated with information indicating a storage area in which the device installation information is stored in the information processing device, and
the state change notifying unit notifies, together with the content of the change, the information processing device of execution of a processing based on the information indicating the storage area and the device installation information.

5. The device installation information distributing apparatus according to claim 4, wherein the device installation information includes a function of storing information indicating that the program is installed through the execution of the processing in the information processing device and a function of updating the setting of the communication with the device based on the content of the change when the information indicating that the program is installed is stored and the content of the change is notified.

6. The device installation information distributing apparatus according to claim 1, wherein the device installation information updater acquires, in addition to the identifier, login information for logging on to the information processing device with an authority with which a program installation is allowed, and updates the device installation information by using the identifier and the login information.

7. The device installation information distributing apparatus according to claim 6, wherein
the device installation information includes login state changing information that provides a function of changing a login state in the information processing device to an administrator login state,
a function to be provided by the login state changing information enables changing a login state in the information processing device to the login state with the authority with which a program installation is allowed based on the login information transmitted to the information processing device, and
the communication setting function in the device installation information enables performing the communication setting by using the identifier included in the device installation information after the login state in the information processing device is changed to the login state with the authority with which a program installation is allowed.

8. The device installation information distributing apparatus according to claim 1, further comprising a device installation information manager configured to manage the device installation information for each model of the device, wherein
the device installation information updater acquires the device installation information corresponding to the model of the device specified in the acquired request.

9. A device installation information distributing method comprising:
acquiring a request to distribute device installation information, the device installation information including a function of installing a program to be installed in an information processing device to use a device connected to the information processing device via a network and a function of setting a communication with the device in accordance with the program;
acquiring an identifier of a target device to be used on the network;
acquiring the device installation information for the target device;
updating the device installation information by using the acquired identifier; and
transmitting the updated device installation information to the information processing device that transmits the request.
